(19) United States
(12) Patent Application Publication
(10) Pub. No.: US 2012/0211945 A1
(43) Pub. Date: Aug. 23, 2012

(54) SEALING PACKING FOR A RECIPROCATING PISTON ROD OF A RECIPROCATING COMPRESSOR

(75) Inventors: Tino LINDNER-SILWESTER, Wien (AT); Christian HOLD, Bisamberg (AT); Christian KERNBICHLER, Enzersdorf an der Fischa (AT); Andreas BRANDL, Wien (AT)

(73) Assignee: HOERBIGER KOMPRESSORTECHNIK HOLDING GMBH

(21) Appl. No.: 13/396,176

(22) Filed: Feb. 14, 2012

(30) Foreign Application Priority Data
Feb. 17, 2011 (AT) A 213/2011

(51) Int. Cl. F16J 15/16

(52) U.S. Cl. 277/508; 277/503

(57) ABSTRACT

A gas-proof sealing packing of a compressor includes a scraper recess on the crankcase-side end containing a gas-proof scraper ring, a sealing ring recess on the cylinder-side end containing a sealing ring arrangement (18), a barrier recess located axially between the scraper recess (15) and the sealing ring recess (17), and a drain line in the sealing packing that is connected with the space between the barrier recess and the scraper recess.

The subject-matter of the invention refers to a sealing apparatus for sealing a reciprocating piston rod of a reciprocating compressor, wherein a first and a second sealing element are provided in the sealing packing that are arranged inside a barrier recess of the sealing packing, and wherein a feed line is provided for the sealing medium that opens into the barrier recess.

In certain applications involving compressors, for example in compressor stations for conveying natural gas, it is becoming increasingly important to minimize leakages of compression media (for example, natural gas) for environmental reasons (not least of all because the requirements mandated by the legislatures are continually being tightened). These leaks occur essentially along the piston rod that travels back and forth and that is normally sealed relative to the compressor housing by so-called sealing packings that are known in the art. Therefore, conventional sealing packings would have to meet high requirements in order to comply with the demands for leak-proofness; a proposition, however, that is not always possible to attain and would, if implemented, at least translate into a considerable increase of complexity in terms of providing sealing action.

WO 2010/079227 A1 discloses a gas-proof seal in a sealing packing that prevents gas from leaking along the piston rod. To this end, a pressurized sealing medium is locked in between two sealing elements thus forming a sealing medium barrier and preventing gas from leaking. In addition, it is further possible to arrange sealing elements having different functions, such as, far example, a scraper ring, a packing ring or a packing ring combination or a hydraulic sealing ring. The seal that is described therein is gas-proof during normal operation. In the event of a malfunction, such as, for example, failure of the hydraulic supply of the sealing medium barrier or damage to the sealing element of the sealing medium barrier, it is no longer possible, however, to guarantee the sealing action, which may result consequently in an emergency shutdown of the compressor. This means that the forcible, undesired shutdown of the compressor is the only possible response to certain extraordinary conditions. A damaged sealing element of the sealing medium barrier can, for example, result in sealing medium being conveyed into the cylinder or the crankcase, which may also result in undesired consequential damage to the compressor (for example, on the piston, piston rod, crank shaft, connecting rod, etc.) and typically leads to a shutdown of the compressor. In particular, over-lubrication of the cylinder should be avoided in this context in order to avoid possible consequential damage. If, for example, the hydraulic supply of the sealing medium barrier fails, the sealing function of the sealing packing no longer exists and it is possible for compression medium to escape from the cylinder into the crankcase and from there into the environment, which may also result in a forcible shutdown of the compressor. Due to the problems as outlined above, the hydraulic supply can, however, not be simply turned off in the event of a malfunction, which means that in the event of an error the entire compressor must be shut down for maintenance and/or damage repair. In practice, this leads to interruptions of operation with a propensity of causing great economic losses.

A further problem of WO 2010/079227 A1 is its need for a very complex, costly configuration of various sealing elements as well as pressure and drain lines for a safe recirculation of the sealing medium, for example, as demonstrated in FIG. 6 of WO 10 2010/079227 A1. This makes an apparatus of this kind, and especially any retrofitting of existing compressors, a complex undertaking and therefore pointless from an economic perspective.

Consequently, the object of the present invention seeks to improve a gas-proof sealing packing according to the prior art in such a way that in the event of malfunction of a component of the sealing packing, such as, for example, of the hydraulic supply or of a sealing element, the functioning of the sealing packing will be maintained at least to such an extent that is sufficient for avoiding any shutdown of the compressor while, at the same time, the sealing packing still has a simple construction.

According to the invention this object is achieved by providing on the crankcase-side end of the sealing packing a scraper recess, in which there is arranged a gas-proof scraper ring, and by providing on the cylinder-side end of the sealing packing a sealing ring recess, inside which there is arranged a sealing ring arrangement, and wherein the barrier recess is axially arranged between the scraper recess and the sealing ring recess, and wherein a drain line is arranged in the sealing packing that is connected with the space between barrier recess and second recess. With this configuration, it can be easily achieved that, in the event of a failure or damage of the sealing medium barrier the gas-proof scraper ring will take over the function of providing gas-proof sealing action, allowing for controlling and safely draining any compression medium that may escape from the cylinder via the drain line. In the event that an error occurs it is thus, nevertheless, possible to maintain the sealing function. This way, it is possible to avoid any shutdown of the compressor, whereby the operational safety of such a sealing packing can be considerably improved.

A spring element is preferably arranged in the barrier recess that pushes the first and second sealing elements axially apart to allow for a safe activation of the sealing medium barrier. The position of the sealing element at rest is thus defined, and it is ensured that the sealing elements are axially pressed against the delimitation of the barrier recess when the hydraulic supply of the sealing medium barrier is activated.

The reduction of the high pressure on the cylinder side can preferably be distributed over several sealing ring arrangements by disposing a further sealing ring recess on the cylinder-side end of the sealing packing that has a further sealing ring arrangement arranged therein. This allows for a reduction of the requirements placed upon an individual sealing ring arrangement.

It is advantageous therein that in a second sealing ring recess a rigid sealing ring is arranged for the reduction of the dynamic pressure peaks of the cylinder-side pressure.

To further increase the operational safety of the sealing packing, it is possible to arrange a further sealing element in one of the sealing ring recesses. This allows even for compensating for a failure of a sealing element of the sealing medium barrier.

An especially simple constructive setup of the sealing packing results, when a barrier recess and/or scraper recess and/or sealing ring recess is/are arranged in a chamber disk.

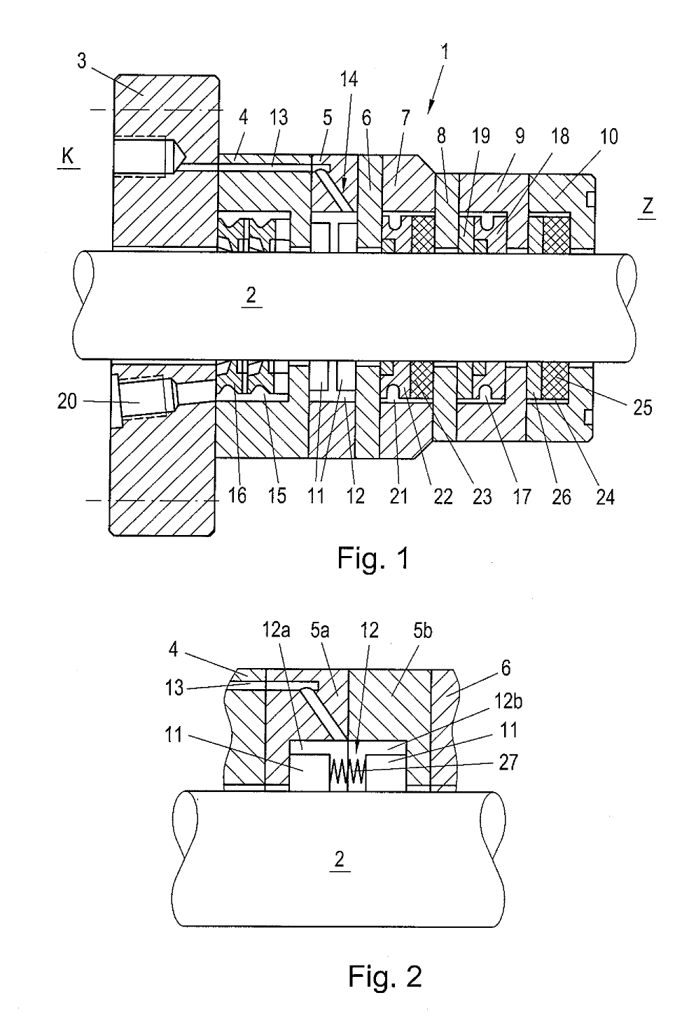

In the following, the present invention will be illustrated in further detail referring to the FIGS. 1 and 2 that show non-limiting advantageous embodiments of the invention. Shown are in:

FIG. 1 a preferred embodiment of a sealing packing; and in

FIG. 2 a further embodiment of a sealing medium barrier.

In an advantageous embodiment according to FIG. 1 the gas-proof seal of the sealing packing 1 comprises a number of chamber disks 3, 4, 5, 7, 9, 10; and in part arranged therein are sealing elements of varying functions. The chamber disks 3, 4, 5, 7, 9, 10 can be connected with each other in a known manner by a continuous bolt. This sealing packing 1 therein is inserted in a generally known manner in the (not shown) housing of a compressor, and wherein a first chamber disk 3 is designed as a flange disk by which the sealing packing 1 can be fastened inside the housing, for example by screws that are distributed along the circumference. The sealing packing 1 provides sealing action between a cylinder-side space Z, having high pressure, and a crankcase-side space K usually having atmospheric pressure. “Sealing action” herein means preventing compression medium, for example natural gas, from travelling from the cylinder-side space Z, for example along the piston rod 2, to the crankcase-side space K thus constituting an undesired leak of compression medium.

To this end, two sealing elements 11 are arranged at an axial distance inside a barrier recess 12 in a barrier chamber disk 5. Naturally, each sealing element 11 can equally be arranged in its own barrier chamber disk 5a, 5b instead of a joint barrier chamber disk 5, as shown in FIG. 2. In this case, the barrier recess 12 would be formed by two recesses 12a, 12b that are connected with each other. Naturally, a further separating disk can be arranged between the two barrier chamber disks 5a, 5b in FIG. 2, as long as the two recesses 12a, 12b constituting the barrier recess 12 remain hydraulically connected with each other.

A hydraulic feed line 13 opens into the barrier recess 12 by which the sealing medium, for example oil, is supplied. The pressure of the sealing medium causes the sealing elements 11 to be pressed, axially against the adjacent chamber disks 4, 6 (as in FIG. 1) and/or against the axial delimitation of the barrier chamber disks 5, 5a, 5b (as in FIG. 2) as well as radially inside against the piston rod 2. This creates a sealing medium barrier 14 that prohibits any flow-through of compression medium along the piston rod 2.

The sealing elements 11 therein can be axially preloaded by a spring element 27 (see FIG. 2) that pushes the two sealing elements 11 axially apart and against the axial delimitation of the barrier recess 12. This way, it is possible to achieve a safe activation of the sealing medium barrier 14 because the positions of the sealing elements 11 are defined.

In addition, a scraper chamber disk 4 is arranged on the crankcase-side end K of the sealing packing 1; presently, it is between the first chamber disk 3 and the barrier chamber disk 5 and/or one of the barrier chamber disks 5a. A gas-proof scraper ring 16, here two gas-proof scraper rings 16 arranged axially one after the other, is arranged in a scraper recess 15 in the scraper chamber disk 4. “Gas-proof” herein means in this context that, aside from unavoidable imperfections (such as manufacturing deviations, roughness, etc.), the scraper ring 16 is free of any defined gas leakage paths in the axial or radial direction. A gas-proof scraper ring of this kind is disclosed, for example, in the Austrian patent application A 216/2010.

At least in one sealing ring chamber disk 9 in a sealing ring recess 17 on the cylinder-side end Z of the sealing packing 1 there is arranged a conventional, known sealing ring arrangement 18, such as, for example, a segmented sealing ring as disclosed in EP 2 35 056 003 A1 or a sealing ring combination that is known in the art consisting, for example, of a sealing ring that is axially located, adjacent radially and tangentially cut. Furthermore, a rigid support ring 19 can be arranged in the sealing ring recess 17 with which the sealing ring arrangement can make axial contact.

In this minimum configuration of the sealing packing 1, meaning a configuration with a sealing medium barrier 14, a crankcase-side K, gas-proof scraper ring 16 in a scraper recess 15 and a cylinder-side Z sealing ring arrangement 18 inside a sealing ring recess 17, the function of the sealing packing 1 is still maintained even when the hydraulic supply of the sealing medium barrier 14 fails, as described below.

During normal operation, pressurized sealing medium is supplied to the barrier recess 12 via the hydraulic feed line 13. The two sealing elements 11 therein are pressed against the axial delimitations of the barrier recess 12 and against the piston rod 2, whereby a gas-proof sealing medium barrier 14 forms. Preferably, the sealing elements 11 should be configured in such a way that as little sealing medium as possible from the sealing medium barrier 14, is lost, for example along the surface of piston rod 2. But because the piston rod 2 travels back and forth there will always be some sealing medium that, adhering to the piston rod's surface, will be conveyed. But, advantageously, this virtually unavoidable leakage of sealing medium should be as minimal as possible, which is achieved by a corresponding design of the sealing elements 11. Any leaking sealing medium on the side of the crankcase K is scraped off from the piston rod 2, thus allowing in as much as possible for the prevention of sealing medium escaping from the sealing packing 1 into the crank case. The scraped off sealing medium can be discharged by a drain line 20 that is connected with the space between the sealing medium barrier 14 and the scraper ring 16 and recirculated, if need be, via the corresponding lines from the sealing medium supply and/or a sealing medium reservoir. The high pressure on the cylinder side that is above the suction pressure is reduced on the sealing ring arrangement 18 on the cylinder-end side end Z of the sealing packing 1, thus allowing for a reduction of the necessary pressure of the hydraulic supply in the sealing medium barrier 14.

If the hydraulic supply of the sealing medium barrier 14 fails or is turned off (see below), the high cylinder-side pressure that is above the suction pressure is reduced at the pressure ring apparatus 18. The gas-proof scraper ring 16 then also assumes the sealing action in the direction of the crank case and any leakage of compression medium that may occur, for example of natural gas, is discharged via the drain line 20 and, for example, flared off. This way, compression medium is prevented from undesirably reaching the crank case and escaping from there in an uncontrolled manner in the environment. Thus, use of the sealing packing 1 can be continued even in the event of an error occurring until the next maintenance measure or repair.

But it is not longer necessary to shut off the compressor in the interim.

If a sealing element 11 of the sealing medium barrier 14 leaks, for example due to excess wear and tear or another type of damage, it is possible to ascertain this state based on the strong increase in the conveyed quantity of sealing medium, because sealing medium 14 is increasingly lost. In this case, the hydraulic supply of the sealing medium barrier 14 can be simply turned off but without essentially impairing the function of the sealing packing 1.

The function of the sealing packing 1 can be improved by disposing further elements. As shown in FIG. 1, further sealing ring arrangements or sealing elements, for example, could conceivably be arranged.

It is thus possible to arrange on the cylinder-side end Z of the sealing packing 1 in a second sealing ring chamber disk 10 and/or third sealing ring chamber disk 7 in a second sealing ring recess 24 and/or in a third sealing ring recess 21 a second sealing ring arrangement 25, for example, as shown, an uncut sealing ring and/or third sealing ring arrangement 22, for example, as shown, a segmented sealing ring according to EP 2 056 003 A1; possibly again in combination with a support ring 26. In a sealing ring arrangement 22, 25 of this type, the cylinder-side pressure is partially reduced, whereby the reduction of the cylinder-side pressure can be advantageously distributed over several sealing ring arrangements 18, 22, 25. In case of an uncut sealing ring, a reduction of the dynamic pressure peaks of the cylinder-side pressure occurs here.

It is also possible to arrange a further sealing element 23, such as, for example, a sealing element 11, as the sealing medium barrier 14 uses, in one of the sealing ring chamber disks 7, 9, 10. If the cylinder-side sealing element 11 of the sealing medium barrier 14 fails, said sealing element 23 can serve for taking over the latter's function. In this case, the sealing medium barrier 14 would be created between the crank-side sealing element 11 and the sealing element 23, thus allowing for realizing another safety function.

If necessary, it is also possible to arrange separating disks 6, 8 between the individual sealing ring chamber disks 3, 4, 5, 5a, 5b, 7, 9, 10, for example to ensure easy assembly of the sealing packing 1.

Naturally, it is also conceivable to configure two or several adjacent chamber disks, for example the scraper chamber disk 4 and the barrier chamber disk 5a or the third sealing ring chamber disk 7 and the barrier chamber disk 5b as individual chamber disks.

1. A gas-proof sealing packing for a reciprocating piston rod (2) of a reciprocating compressor, the sealing package including a barrier recess containing first and second sealing elements (11), a feed line (13) for a sealing medium that opens up into the barrier recess (12), a scraping recess (15) on a crankcase-side end (K) of the sealing packing (1) containing a gas-proof scraper ring (16), a sealing ring recess (17) on a cylinder-side end (Z) of the sealing packing (1) containing a sealing ring arrangement (18), wherein the barrier recess (12) is arranged axially between the scraper recess (15) and the sealing ring recess (17), and including a drain line (20) in the sealing packing (1) that is connected with a space between the barrier recess (12) and the scraper recess (15).

2. The gas-proof sealing packing according to claim 1, including a spring element (27) in the barrier recess (12) that presses the first and second sealing elements (11) axially apart.

3. The gas-proof sealing packing according to claim 1, including on the cylinder-side end (Z) of the sealing packing (1) a further sealing ring recess containing a further sealing ring arrangement.

4. The gas-proof sealing packing according to claim 3, including a second sealing ring arrangement in a second sealing ring recess (24).

5. The gas-proof sealing packing according to claim 4, including a third sealing ring arrangement (22) in a third sealing ring recess (21).

6. The gas-proof sealing packing according to claim 5, including a further sealing element (23) in one of the further sealing ring recesses (21, 24).

7. The gas-proof sealing packing according to claim 5, wherein the barrier recess (12) and/or the scraper recess (15) and/or a sealing ring recess (17, 21, 24) is/are arranged in a chamber disk (4, 5, 7, 9, 10).
